(19) United States
(12) Patent Application Publication
(10) Pub. No.: US 2005/0164788 A1
(43) Pub. Date: Jul. 28, 2005

(54) Gaming device audio status indicator

(75) Inventor: Jacek Grabiec, Chicago, IL (US)

Correspondence Address: SCHWEGMAN, LUNDBERG, WOESSNER & KLUTH, P.A., P.O. BOX 2938, MINNEAPOLIS, MN, 55402-0938, US

(73) Assignee: WMS Gaming Inc.

(21) Appl. No.: 10/765,024

(22) Filed: Jan. 26, 2004

(51) Int. Cl. A63F 13/00

(52) U.S. Cl. 463/35; 463/20

(57) ABSTRACT

A computerized gaming system includes a gaming module, which includes a processor and gaming code which is operable when executed on the processor to conduct a game of chance on which monetary value can be wagered. An audio module is operable to report game configuration and technical information to a game administrator.

### FIELD OF THE INVENTION

The invention relates generally to gaming systems, and more specifically to gaming systems having an audio device operable to indicate gaming machine status.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. This involves careful calculation and presentation of the outcomes of the games and careful design of the user interfaces, such as the video touchscreen and the graphics displayed, the credit system, and the operating state in case of a malfunction, power outage, or other unanticipated computer event.

To ensure proper operation of computerized gaming systems, many such systems employ indicators that alert a game owner to the game's status. These indicators are typically conveyed via one or more flashing light-emitting diodes (LEDs) or via an error code presented as a short alphanumeric sequence on a 7-segment display such as is often found on electronic clocks or stereo systems. These alphanumeric codes or flashing light sequences are then looked up in a table in an owner's manual, which indicates the meaning of the code sequence. Some codes convey hardware-related functions or indication of a failed component, such as a power supply out of range, or a fan that has stopped working. Other codes reveal the state of a machine, such as whether a machine is in an operating state, is in a test or service mode, or has detected various software-related errors such as a memory page fault.

Even in systems having a failed video screen or which rely on traditional mechanical presentation of gaming results such as a mechanical reel slot machine, a wide variety of machine status indications can be presented. This system may lack sophistication, but performs the needed function for those who have retrieved a lookup table or an owner's manual, and have accurately decoded the presented message. What is desired is a system that enables a gaming system manager or owner to more easily recognize and interpret the various status indicators and error conditions conveyed by a gaming machine.

### SUMMARY OF THE INVENTION

The present invention provides in one embodiment a computerized gaming system including an audio module that is operable to report game configuration and technical information to a game administrator or user. The gaming system further comprises a gaming module, which includes a processor and gaming code which is operable when executed on the processor to conduct a game of chance on which monetary value can be wagered.

### BRIEF DESCRIPTION OF THE FIGURES

FIG. 1 shows a computerized gaming system having an audio module, consistent with an embodiment of the present invention.

FIG. 2 shows a menu system as may be used with some embodiments of the present invention.

FIG. 3 is a flowchart showing a method of managing a computerized gaming system, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in various embodiments a computerized gaming system having an audio module that is operable to report game configuration and technical information to a game administrator. The gaming systems typically also include a gaming module, which includes a processor and gaming code which is operable when executed on the processor to conduct a game of chance on which monetary value can be wagered. In normal operation, a game player plays the game repeatedly without assistance or intervention from a game's owner or administrator, but certain functions such as configuration and troubleshooting will require periodic administrator interaction with the gaming system.

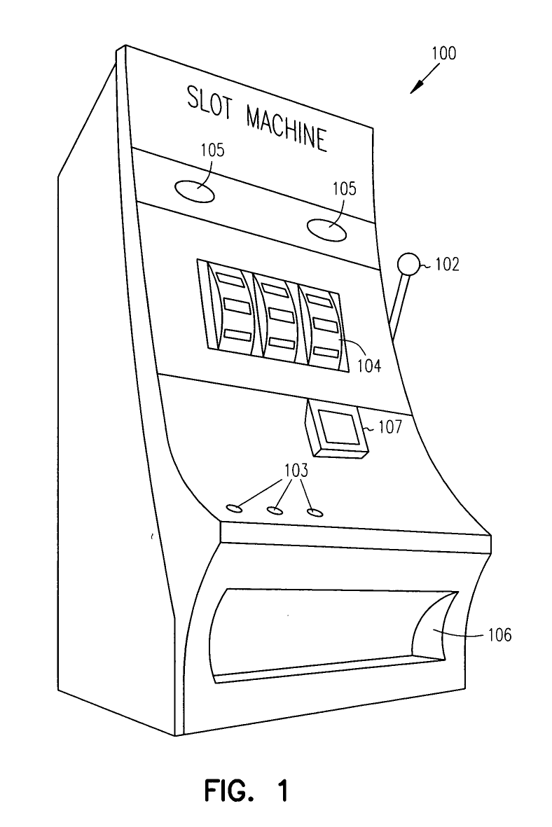

FIG. 1 illustrates a computerized gaming system having an audio module, consistent with an embodiment of the present invention. The computerized gaming system shown generally at 100 features a arm-actuated slot machine game, which is played with arm 102. Various other game functions can be controlled with buttons 103, and the results of each play of the game are shown on mechanical reels 104. Speakers 105 are connected to an audio system, which in various embodiments of the game are used to play music, to indicate tilt or other attention conditions, and to indicate the state of a game being played. Winnings are paid to the gamer via coin tray 106, or via a coded identifier such as a smart card or magnetic stripe card through a card interface 107.

In operation, the game player inserts coins or tokens into the gaming system, or inserts credits through another means such as a smart card or other identifier. The credits to be wagered are specified, such as by using the buttons 103, and the slot machine game is initiated by pulling the handle 102. Each of the three reels 104 is set in motion, and stops in a position determined by a processor and software that control the gaming system. Winnings are then credited to the game player's credits, or are paid out via the coin tray 106. Upon leaving the game, credits not yet paid out are paid to the game player, such as through coin tray 106 or through a card interface device 107.

Because various game functions, such as odds management, management of credits, and game options available to a player are configurable in many games, the game administrator typically sets up or configures a game before making it available to players. While this can be performed by methods such as by video touchscreen on some gaming systems, other gaming systems such as the mechanical reel slot gaming system shown generally at 100 have no such game administrator interface available.

The present invention provides an audio interface for the game administrator in some embodiments, using one or more speakers 105 to communicate with the game administrator via voice reproduction or synthesis. One example embodiment of such a system includes functionality to convey a variety of information, including setup menus, error information, and reporting information to the game administrator.

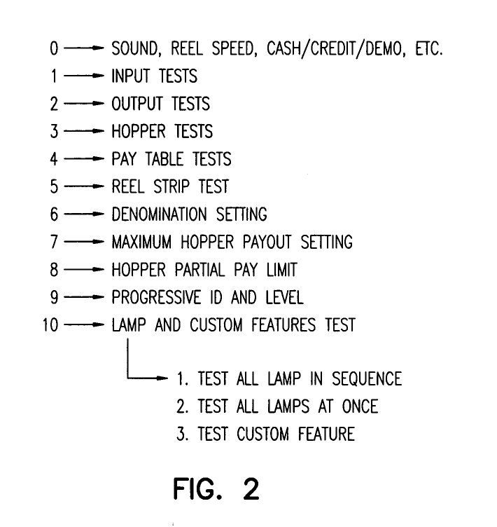

As an example, a game administrator may unlock and open the computerized gaming system 100 and actuate a switch or diagnostic button, placing the machine in a service or configuration mode. A configuration module, implemented in hardware, software, or some combination, guides the game administrator through a series of menus to perform various functions by playing an appropriate voice message through the one or more speakers 105. The voice system will prompt the game administrator to select a specific game administration function, such as by pressing a maximum bet button proceed to the next menu item and pressing a spin reels button to select the present item. An example of a menu system such as might be used in a typical reel slot machine is shown in FIG. 2.

Upon entering the diagnostic mode, the audio system would first announce via reproduced voice “Zero. Sound, reel speed, cash, credit, demo”. If these were the functions the game administrator intended to select, the administrator would push the spin reels button to select that item, otherwise pressing the max bet button to proceed to menu item 1. The menus will in some embodiments of the invention form a nested hierarchy of menus, as is shown for element 10 of FIG. 2. If the game administrator chooses menu item 10, the lamp and custom features test, a sub-menu is then presented via the same voice audio interface. In this example, the administrator has the option of testing all lamps in sequence, testing all lamps at one time, or testing an installed custom feature of the gaming system.

In a further embodiment of the invention, the gaming system prompts the user on testing and fixing certain problems. As an example, if the “One. Test all lamps in sequence” item is selected from the sub-menu of menu item 10, the gaming system may walk the administrator through verification of each light, asking that a certain button be pushed if the light is operating properly, and another button be pressed if the light fails to operate. When a failed light is found, the audio voice system can in some further embodiments guide the administrator through the steps needed to repair and verify the repair to the gaming system.

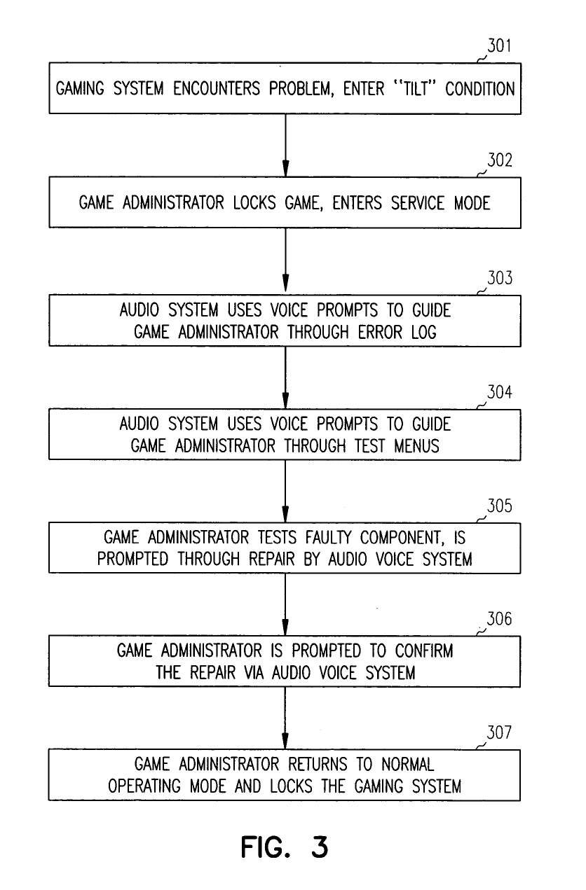

FIG. 3 illustrates a method of using an audio voice module in a computer gaming system to perform administrative functions, consistent with an embodiment of the present invention. The gaming system detects a problem or inconsistency at 301, and enters a tilt condition, halting normal play operation. At 302, a game administrator arrives to service the gaming system, and unlocks and opens the system. The game administrator enters a service mode, such as by actuating a switch or providing some other input, and the gaming system's audio system reports the contents of the error log to the game administrator at 303 via a reproduced voice. The last entry or entries in the error log as announced to the game administrator will likely suggest that the tilt condition was entered as a result of one or more specific problems detected within the machine.

At 304, the game administrator enters the test menus, such as by using the buttons 103 of FIG. 1, and proceeds through the test menus to test the suspected failed component or components at 305. The game administrator finds a faulty component using the voice-guided test menu, and is prompted to perform certain steps to repair the failed component. Once the steps to repair or replace the failed component have been completed, the game administrator is prompted to test the repaired component to ensure that it is functioning correctly at 306. If the component is properly repaired as expected, the game administrator returns the repaired gaming system to its normal operating status at 307, and locks the gaming system.

In further embodiments of the invention, the audio module is operable to communicate game status not only to the game administrator, but also to a game player or other user. One example of such a system is where a gaming system audibly provides guidance to a game player in the event of a tilt condition, or in the case of other malfunction. Audio modules in other embodiments of the gaming system will function even though video game configuration and status prompts may be designed as a part of the gaming system, such as for use when the video display is malfunctioning or when the game administrator prefers audio prompts such as for fixing a problem inside the gaming system cabinet.

Other embodiments of gaming systems having an audio voice guide will incorporate a variety of additional functions, such as multi-language support for the voice system. The game administrator selects one of the available languages, and voice prompts are then provided in that language until a different language is selected. Each game administrator to use the system could also select a preferred language that differs from the default language, such that French-speaking Canadians could select French instead of English, or Spanish-speaking Americans could select Spanish instead of English.

These examples have shown ways in which the audio voice module of the present invention can be incorporated into various gaming systems, and can provide a game administrator with feedback and prompts that would otherwise be difficult to convey. Gaming machines with mechanical slot reels are preferred to video machines by many gamers, and will likely remain an important part of the gaming market for years to come, contributing to the demand for an audio module having voice capability for communicating information to game administrators such as service technicians, casino managers, and gaming system owners.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized gaming system, comprising:
a gaming module, comprising a processor and gaming code which is operable when executed on the processor to conduct a game of chance on which monetary value can be wagered; and
an audio module, the audio module operable to report information comprising game technical information to a game administrator.

2. The computerized gaming system of claim 1, wherein the computerized gaming system comprises a mechanical user interface.

3. The computerized gaming system of claim 2, wherein the mechanical user interface is a mechanical reel slot machine interface.

4. The computerized gaming system of claim 1, wherein game technical information comprises at least one of a game administrator menu, a game administrator help menu, a game troubleshooting menu, a game test menu, and a game setup menu.

5. The computerized gaming system of claim 1, the audio module further operable to report error condition information.

6. The computerized gaming system of claim 5, wherein the audio module is operable to report error condition information upon actuation by a game administrator.

7. The computerized gaming system of claim 1, further comprising a monitoring module, the monitoring module operable to monitor the state of one or more components of the computerized gaming system, the audio module further operable to report monitoring module data to a game technician.

8. The computerized gaming system of claim 1, wherein the audio system is further operable to convey information regarding an executing game of chance to a user.

9. The computerized gaming system of claim 1, the audio module operable to report information comprising game technical information to a game administrator when the game of chance is not executing.

10. The computerized gaming system of claim 1, the audio module further operable to prompt a game administrator to perform test or configuration functions.

11. The computerized gaming system of claim 1, the audio module operable to report information in one or more languages.

12. A method of providing game administrator interface with a computerized gaming system, comprising:
reporting game technical information of the computerized gaming system to a game administrator via an audio system, the computerized gaming system operable to execute gaming code on a processor to conduct a game of chance on which monetary value can be wagered.

13. The method of claim 12, wherein the computerized gaming system comprises a mechanical user interface.

14. The computerized gaming system of claim 13, wherein the mechanical user interface is a mechanical reel slot machine interface.

15. The method of claim 12, wherein game technical information comprises at least one of a game administrator menu, a game administrator help menu, a game troubleshooting menu, a game test menu, and a game setup menu.

16. The computerized gaming system of claim 1, wherein game technical information comprises error condition information.

17. The method of claim 12, wherein the game technical information is reported upon actuation by a game administrator.

18. The method of claim 12, further comprising monitoring the state of one or more components of the computerized gaming system, and reporting the monitored state as game technical information to the game administrator via the audio system.

19. The method of claim 12, further comprising conveying information regarding an executing game of chance to a user via the audio system.

20. The method of claim 12, the audio system operable to report information comprising game technical information to a game administrator when the game of chance is not executing.

21. The method of claim 12, further comprising prompting a game administrator via the audio system to perform test or configuration functions.

22. The method of claim 12, the audio system operable to convey information to a game administrator in one or more languages.

23. A computerized gaming system, comprising:
a gaming module, comprising a processor and gaming code which is operable when executed on the processor to conduct a game of chance on which monetary value can be wagered;
a configuration module, operable to facilitate at least one of gaming system configuration or troubleshooting; and
an audio module, the audio module operable to provide an audio voice interface to the configuration module.

24. The computerized gaming system of claim 23, wherein the audio voice interface comprises a hierarchal menu conveyed by voice.

25. The computerized gaming system of claim 23, wherein the computerized gaming system comprises a game having a mechanical interface operable to convey results of the game of chance.

26. The computerized gaming system of claim 23, the audio module further operable to convey audio to a player of the game of chance.

27. A method of managing a computerized gaming system, comprising:
reporting game configuration module information to a game administrator through voice via an audio module operatively coupled to a configuration module, the game configuration module operable to facilitate at least one of configuration or troubleshooting the computerized gaming system, the computerized gaming system operable to execute gaming code on a processor to conduct a game of chance on which monetary value can be wagered.

28. The method of claim 27, further comprising:
receiving game configuration module input from a game administrator in response to audio conveyed via the audio module.

29. The method of claim 28, wherein the game configuration module input is received via actuating controls configured to provide input for the game of chance.

30. The method of claim 28, wherein the game configuration module input is received via actuating one or more switches.

31. The method of claim 27, reporting game configuration module information to a game administrator through voice via an audio module comprises conveying a hierarchal menu by voice.

32. The method of claim 27, wherein reporting game configuration module information to a game administrator through voice via an audio module comprises conveying such information in a selected language.
